(19) United States
(12) Patent Application Publication
(10) Pub. No.: US 2015/0312558 A1
(43) Pub. Date: Oct. 29, 2015

(54) STEREOSCOPIC RENDERING TO EYE POSITIONS

(71) Applicants: Quentin Simon Charles Miller, Sammamish, WA (US); Drew Steedly, Redmond, WA (US); Gerhard Schneider, Seattle, WA (US)

(72) Inventors: Quentin Simon Charles Miller, Sammamish, WA (US); Drew Steedly, Redmond, WA (US); Gerhard Schneider, Seattle, WA (US)

(21) Appl. No.: 14/265,225

(22) Filed: Apr. 29, 2014

(51) Int. Cl. H04N 13/04

(52) U.S. Cl. CPC H04N 13/0402; H04N 13/0484

(57) ABSTRACT

Enacted in a stereoscopic display system, a method to display a virtual object at a specified distance in front of an observer. The method includes sensing positions of the right and left eyes of the observer, and based on these positions, shifting a right or left display image of the virtual object. The shift is of such magnitude and direction as to confine the positional disparity between the right and left display images to a direction parallel to an interocular axis of the observer, in an amount to place the virtual object at the specified distance.

### BACKGROUND

In recent years, three-dimensional (3D) display technology has undergone rapid development, particularly in the consumer market. High-resolution 3D glasses and visors are now available to the consumer. Using state-of-the-art microprojection technology to project stereoscopically related images to the right and left eyes, these display systems immerse the wearer in a convincing virtual reality. Nevertheless, certain challenges remain for 3D display systems marketed for consumers. One issue is the discomfort a wearer may experience due to misalignment of the display system relative to the wearer's eyes.

### SUMMARY

One embodiment of this disclosure provides a method to display a virtual object at a specified distance in front of an observer. Enacted in a stereoscopic display system, the method includes sensing positions of the right and left eyes of the observer and, based on these positions, shifting a right or left display image of the virtual object. The shift is of such magnitude and direction as to confine the positional disparity between the right and left display images to a direction parallel to an interocular axis of the observer, in an amount to place the virtual object at the specified distance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of a wearable stereoscopic display system and a computer system in accordance with an embodiment of this disclosure.

FIG. 2 shows aspects of a right or left optical system and associated display window in accordance with an embodiment of this disclosure.

FIGS. 3 and 4 illustrate stereoscopic display of a virtual object in accordance with an embodiment of this disclosure.

FIG. 5 demonstrates misalignment of a wearable stereoscopic display system relative to the eyes of the wearer.

FIG. 6 shows an example pupil position and its center of rotation about the eye.

FIG. 7 illustrates a method to display a virtual object at a specified distance in front of an observer in accordance with an embodiment of this disclosure.

FIG. 8 shows aspects of an example computing system in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

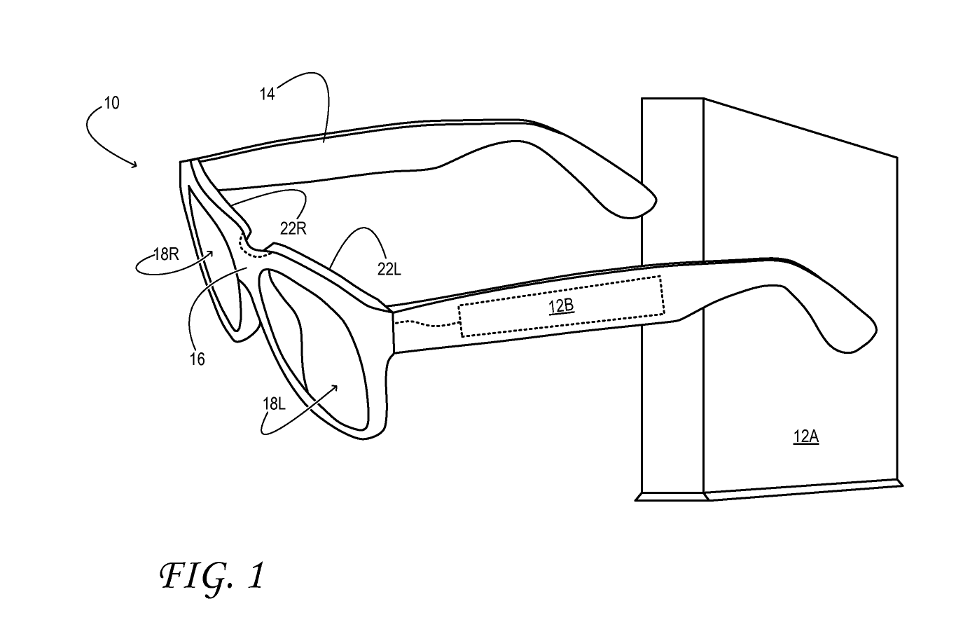

FIG. 1 shows aspects of a wearable stereoscopic display system 10 operatively coupled to a computer system 12A. The illustrated display system resembles ordinary eyewear. It includes an ear-fitting frame 14 with a nose bridge 16 to be positioned on the wearer's face. The display system also includes a right display window 18R and a left display window 18L. In some embodiments, the right and left display windows 18 are wholly or partly transparent from the perspective of the wearer, to give the wearer a clear view of his or her surroundings. This feature enables computerized display imagery to be admixed with imagery from the surroundings, for an illusion of ‘augmented reality’ (AR).

In some embodiments, display imagery is transmitted in real time to display system 10 from computer system 12A. The display imagery may be transmitted in any suitable form—viz., type of transmission signal and data structure. The signal encoding the display imagery may be carried over a wired or wireless communication link of any kind to microcontroller 12B of the display system. In other embodiments, at least some of the display-image composition and processing may be enacted in the microcontroller.

Continuing in FIG. 1, microcontroller 12B is operatively coupled to right and left optical systems 22R and 22L. In the illustrated embodiment, the microcontroller is concealed within the display-system frame, along with the right and left optical systems. The microcontroller may include suitable input/output (IO) componentry to enable it to receive display imagery from computer system 12A. The microcontroller may also include position-sensing componentry—e.g., a global-positioning system (GPS) receiver, a gyroscopic sensor or accelerometer to assess head orientation and/or movement, etc. When display system 10 is in operation, microcontroller 12B sends appropriate control signals to right optical system 22R which cause the right optical system to form a right display image in right display window 18R. Likewise, the microcontroller sends appropriate control signals to left optical system 22L which cause the left optical system to form a left display image in left display window 18L. The wearer of the display system views the right and left display images through the right and left eyes, respectively. When the right and left display images are composed and presented in an appropriate manner (vide infra), the wearer experiences the illusion of a virtual object at a specified position, and having specified 3D content and other display properties. It will be understood that a ‘virtual object’, as used herein, may be an object of any desired complexity and need not be limited to a singular object. Rather, a virtual object may comprise a complete virtual scene having both foreground and background portions. A virtual object may also correspond to a portion or locus of a larger virtual object.

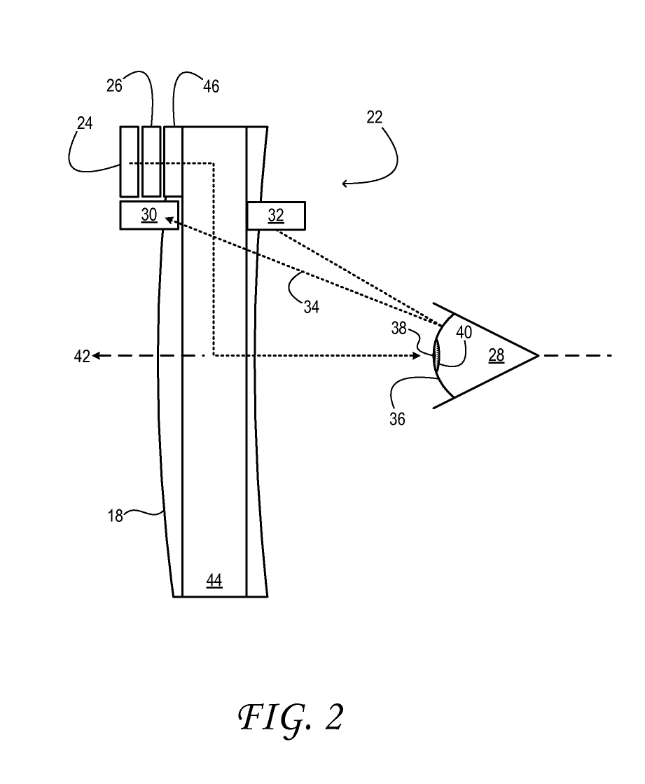

FIG. 2 shows aspects of right or left optical system 22 and an associated display window 18 in one, non-limiting embodiment. The optical system includes a backlight 24 and a liquid-crystal display (LCD) array 26. The backlight may include an ensemble of light-emitting diodes (LEDs)—e.g., white LEDs or a distribution of red, green, and blue LEDs. The backlight may be situated to direct its emission through the LCD array, which is configured to form a display image based on the control signals from microcontroller 12B. The LCD array may include numerous, individually addressable pixels arranged on a rectangular grid or other geometry. In some embodiments, pixels transmitting red light may be juxtaposed in the array to pixels transmitting green and blue light, so that the LCD array forms a color image. The LCD array may be a liquid-crystal-on-silicon (LCOS) array in one embodiment. In other embodiments, a digital micromirror array may be used in lieu of the LCD array, or an active-matrix LED array may be used instead. In still other embodiments, scanned-beam technology may be used to form the display image. It is to be understood that herein-described stereoscopic rendering techniques are compatible with any appropriate display technology.

Continuing in FIG. 2, optical system 22 also includes an eye-tracking sensor configured to sense a position of the right or left eye 28 of the wearer of display system 10. In the embodiment of FIG. 2, the eye-tracking sensor takes the form of imaging system 30, which images light from eye lamp 32 reflected off the wearer's eye. The eye lamp may include an infrared or near-infrared LED configured to illuminate the eye. In one embodiment, the eye lamp may provide relatively narrow-angle illumination, to create a specular glint 34 on the cornea 36 of the eye. Imaging system 30 includes at least one camera configured to image light in the emission-wavelength range of the eye lamp. This camera may be arranged and otherwise configured to capture light from the eye lamp, which is reflected from the eye. Image data from the camera is conveyed to associated logic in microcontroller 12B or in computer system 12A. There, the image data may be processed to resolve such features as pupil center 38, pupil outline 40, and/or one or more specular glints 34 from the cornea. The locations of such features in the image data may be used as input parameters in a model—e.g., a polynomial model—that relates feature position to the gaze vector 42 of the eye. In some embodiments, the model may be calibrated during set-up of display system 10—e.g., by drawing the wearer's gaze to a moving target or to a plurality of fixed targets distributed across the wearer's field of view, while recording the image data and evaluating the input parameters. The wearer's gaze vector may be used in various ways in AR applications. For example, it may be used to determine where and at what distance to display a notification or other virtual object that the wearer can resolve without changing her current focal point.

In some embodiments, the display image from LCD array 26 may not be suitable for direct viewing by the wearer of display system 10. In particular, the display image may be offset from the wearer's eye, may have an undesirable vergence, and/or a very small exit pupil (i.e., area of release of display light, not to be confused with the wearer's anatomical pupil). In view of these issues, the display image from the LCD array may be further conditioned en route to the wearer's eye, as further described below.

In the embodiment of FIG. 2, the display image from LCD array 26 is received into a vertical pupil expander 44. The vertical pupil expander lowers the display image into the wearer's field of view, and in doing so, expands the exit pupil of the display image in the ‘vertical’ direction. In this context, the vertical direction is the direction orthogonal to the wearer's interocular axis and to the direction that the wearer is facing. From vertical pupil expander 44, the display image is received into a horizontal pupil expander, which may be coupled into or embodied as display window 18. In other embodiments, the horizontal pupil expander may be distinct from the display window. Either way, the horizontal pupil expander expands the exit pupil of the display image in the ‘horizontal’ direction. The horizontal direction, in this context, is the direction parallel to the interocular axis of the wearer of display system 10—i.e., the direction in and out of the page in FIG. 2. By passing through the horizontal and vertical pupil expanders, the display image is presented over an area that covers the eye. This enables the wearer to see the display image over a suitable range of horizontal and vertical offsets between the optical system and the eye. In practice, this range of offsets may reflect factors such as variability in anatomical eye position among wearers, manufacturing tolerance and material flexibility in display system 10, and imprecise positioning of the display system on the wearer's head.

In some embodiments, optical system 22 may apply optical power to the display image from LCD array 26, in order to adjust the vergence of the display image. Such optical power may be provided by the vertical and/or horizontal pupil expanders, or by lens 46, which couples the display image from the LCD array into the vertical pupil expander. If light rays emerge convergent or divergent from the LCD array, for example, the optical system may reverse the image vergence so that the light rays are received collimated into the wearer's eye. This tactic can be used to form a display image of a far-away virtual object. Likewise, the optical system may be configured to impart a fixed or adjustable divergence to the display image, consistent with a virtual object positioned a finite distance in front of the wearer. In some embodiments, where lens 46 is an electronically tunable lens, the vergence of the display image may be adjusted dynamically based on a specified distance between the observer and the virtual object being displayed.

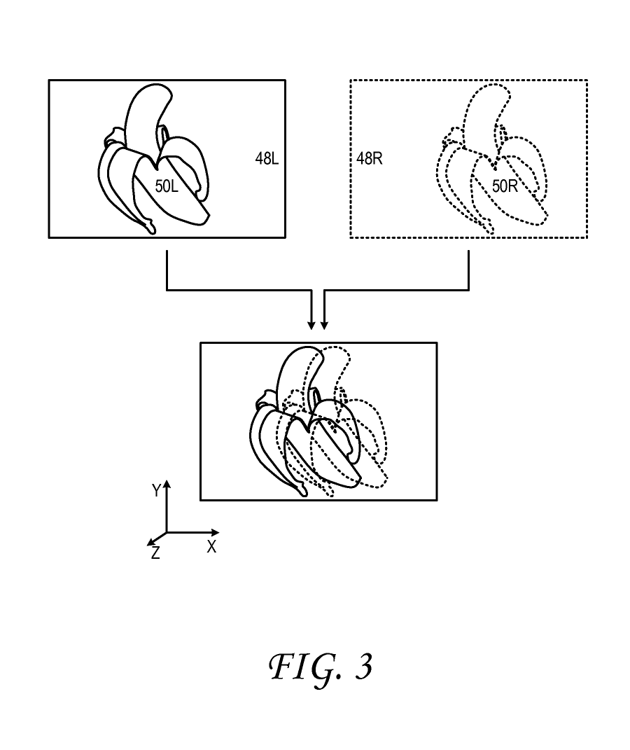

An observer's perception of distance to a virtual display object is affected not only by display-image vergence but also by positional disparity between the right and left display images. This principle is illustrated by way of example in FIG. 3. FIG. 3 shows right and left image frames 48R and 48L, overlaid upon each other for purposes of illustration. The right and left image frames correspond to the image-forming areas of LCD arrays 26 of the right and left optical systems, respectively. As such, the right image frame encloses right display image 50R, and the left image frame encloses left display image 50L. Rendered appropriately, the right and left display images may appear as a virtual 3D object of any desired complexity. In the example of FIG. 3, the virtual object includes a surface contour having a depth coordinate Z associated with each pixel (X, Y) of the right or left display image. The desired depth coordinate may be simulated in the following manner, with reference to FIG. 4.

At the outset, a distance Z₀ to a focal plane F of display system 10 is chosen. The left and right optical systems are then configured to present their respective display images at a vergence appropriate for the chosen distance. In one embodiment, Z₀ may be set to ‘infinity’, so that each optical system presents a display image in the form of collimated light rays. In another embodiment, Z₀ may be set to two meters, requiring each optical system to present the display image in the form of diverging light. In some embodiments, Z₀ may be chosen at design time and remain unchanged for all virtual objects presented by the display system. In other embodiments, each optical system may be configured with electronically adjustable optical power, to allow Z₀ to vary dynamically according to the range of distances over which the virtual object is to be presented.

Once the distance Z₀ to the focal plane has been established, the depth coordinate Z for every surface point P of the virtual object 52 may be set. This is done by adjusting the positional disparity of the two loci corresponding to point P in the right and left display images, relative to their respective image frames. In FIG. 4, the locus corresponding to point P in the right image frame is denoted P_{R}, and the corresponding locus in the left image frame is denoted P_{L}. In FIG. 4, the positional disparity is positive—i.e., P_{R} is to the right of P_{L} in the overlaid image frames. This causes point P to appear behind focal plane F. If the positional disparity were negative, P would appear in front of the focal plane. Finally, if the right and left display images were superposed (no disparity, P_{R} and P_{L} coincident) then P would appear to lie directly on the focal plane. Without tying this disclosure to any particular theory, the positional disparity D may be related to Z, Z₀, and to the interpupilary distance (IPD) by

$$D = IPD \times ( 1 - \frac{{Z}_{0}}{Z} ) .$$

In the approach described above, the positional disparity sought to be introduced between corresponding loci of the right and left display images is parallel to the interpupilary axis of the wearer of display system 10. Here and elsewhere, positional disparity in this direction is called ‘horizontal disparity,’ irrespective of the orientation of the wearer's eyes or head. Introduction of horizontal disparity is appropriate for virtual object display because it mimics the effect of real-object depth on the human visual system, where images of a real object received in the right and left eyes are naturally offset along the interpupilary axis. If an observer chooses to focus on such an object, and if the object is closer than infinity, the eye muscles will tend to rotate each eye about its vertical axis, to image that object onto the fovea of each eye, where visual acuity is greatest.

In contrast, vertical disparity between the left and right display images is uncommon in the natural world and unuseful for stereoscopic display. ‘Vertical disparity’ is the type of positional disparity in which corresponding loci of the right and left display images are offset in the vertical direction—viz., perpendicular to the IPA and to the direction that the observer is facing. Although the eye musculature can rotate the eyes up or down to image objects above or below an observer's head, this type of adjustment invariably is done on both eyes together. The eyes have quite limited ability to move one eye up or down independent of the other, so when presented with an image pair having vertical disparity, eye fatigue and/or headache results as the eye muscles strain to bring each image into focus.

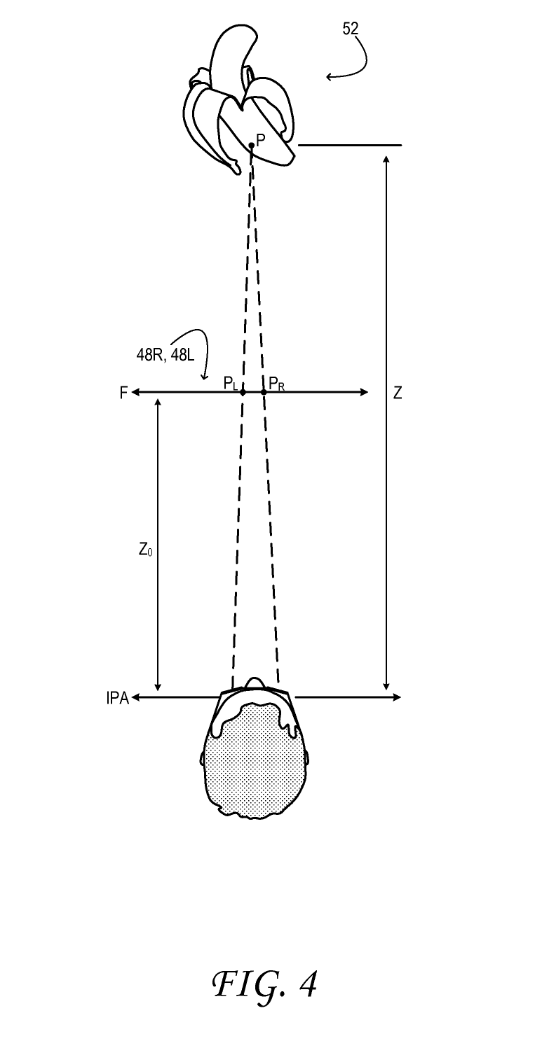

Based on the description provided herein, the skilled reader will understand that misalignment of display system 10 to the wearer's eyes is apt to introduce a component of vertical disparity between the right and left display images. Such misalignment may occur due to imprecise positioning of the display system on the wearer's face, as shown in FIG. 5, asymmetry of the face (e.g., a low ear or eye), or strabismus, where at least one pupil may adopt an unexpected position, effectively tilting the ‘horizontal’ direction relative to the wearer's face.

The above issue can be addressed by leveraging the eye-tracking functionality built into display system 10. In particular, each imaging system 30 may be configured to assess a pupil position of the associated eye relative to a frame of reference fixed to the display system. With the pupil position in hand, the display system is capable of shifting and scaling the display images by an appropriate amount to cancel any vertical component of the positional disparity, and to ensure that the remaining horizontal disparity is of an amount to place the rendered virtual object at the specified distance in front of the observer.

The approach outlined above admits of many variants and equally many algorithms to enact the required shifting and scaling. In one embodiment, logic in computer system 12A or microcontroller 12B maintains a model of the Cartesian space in front of the observer in a frame of reference fixed to display system 10. The observer's pupil positions, as determined by the eye-tracking sensors, are mapped onto this space, as are the superimposed image frames 48R and 48L, which are positioned at the predetermined depth Z₀. (The reader is again directed to FIGS. 3 and 4.) Then, a virtual object 52 is constructed, with each point P on a viewable surface of the object having coordinates X, Y, and Z, in the frame of reference of the display system. For each point on the viewable surface, two line segments are constructed—a first line segment to the pupil position of the observer's right eye and a second line segment to the pupil position of the observer's left eye. The locus P_{R} of the right display image, which corresponds to point P, is taken to be the intersection of the first line segment in right image frame 48R. Likewise, the locus P_{L} of the left display image is taken to be the intersection of the second line segment in left image frame 48L. This algorithm automatically provides the appropriate amount of shifting and scaling to eliminate the vertical disparity and to create the right amount of horizontal disparity to correctly render the viewable surface of the virtual object, placing every point P at the required distance from the observer.

In some embodiments, the required shifting and scaling may be done in the frame buffers of one or more graphics-processing units (GPUs) of microcontroller 12B, which accumulate the right and left display images. In other embodiments, electronically adjustable optics in optical systems 22 (not shown in the drawings) may be used to shift and/or scale the display images by the appropriate amount.

Despite the benefits of eliminating vertical disparity between the component display images, it may not be desirable, in general, to shift and scale the display images to track pupil position in real time. In the first place, it is to be expected that the wearer's eyes will make rapid shifting movements, with ocular focus shifting off the display content for brief or even prolonged periods. It may be distracting or unwelcome for the display imagery to constantly track these shifts. Further, there may be noise associated with the determination of pupil position. It could be distracting for the display imagery to shift around in response to such noise. Finally, accurate, moment-to-moment eye tracking with real-time adjustment of the display imagery may require more compute power than is offered in a consumer device.

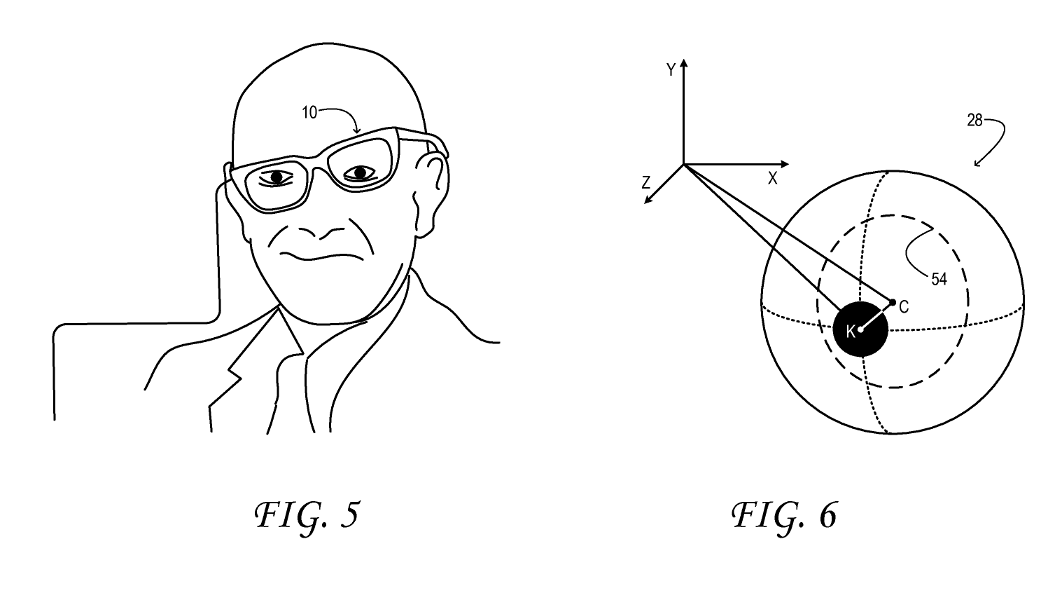

One way to address each of the above issues is to measure and use the rotational center of the eye in lieu of the instantaneous pupil position in the above approach. In one embodiment, the rotational center of the eye may be determined from successive measurements of pupil position recorded over time. FIG. 6 shows aspects of this approach in one embodiment. In effect, the rotational center C can be used as a more stable, and less noisy surrogate for the pupil position K. Naturally, this approximation is most valid when the observer is looking directly forward, so that the center of rotation is directly behind the pupil, and least valid when the observer is looking up, down, or off to the side. Without tying this disclosure to any particular theory, it is believed that the approximation is effective because the brain works much harder to resolve depth for images received in fovea 54—i.e., when the gaze direction is forward or nearly so. Small amounts of vertical disparity in off-fovea images are less likely to trigger unnatural accommodation attempts by the eye musculature.

No aspect of the foregoing description or drawings should be interpreted in a limiting sense, for numerous variants lie within the spirit and scope of this disclosure. For instance, the eye-tracking approaches described above are provided only by way of example. Other types of eye-tracking componentry may be used instead, and indeed this disclosure is consistent with any sensory approach that can be used to locate the pupil position or rotational center for the purposes set forth herein. Further, although display system 10 of FIG. 1 is a near-eye display system in which the right display image is formed behind a right display window, and the left display image is formed behind a left display window, the right and left display images may also be formed by the same image-forming array. With a shutter-based near-eye display, for example, the same image-forming array alternates between display of the right- and left-eye images, which are guided to both the right and left display windows. An electro-optical (e.g., liquid-crystal based) shutter is arranged over each eye and configured to open only when the image intended for that eye is being displayed. In still other embodiments, the right and left display images may be formed on the same screen. In a display system for a laptop computer, or home-theatre system configured for private viewing, the right display image may be formed on a display screen using light of one polarization state, and the left display image may be formed on the same display screen using light of different polarization state. Orthogonally aligned polarization filters in the observer's eyewear may be used to ensure that the each display image is received in the appropriate eye.

The configurations described above enable various methods to display a virtual object. Some such methods are now described, by way of example, with continued reference to the above configurations. It will be understood, however, that the methods here described, and others within the scope of this disclosure, may be enabled by different configurations as well.

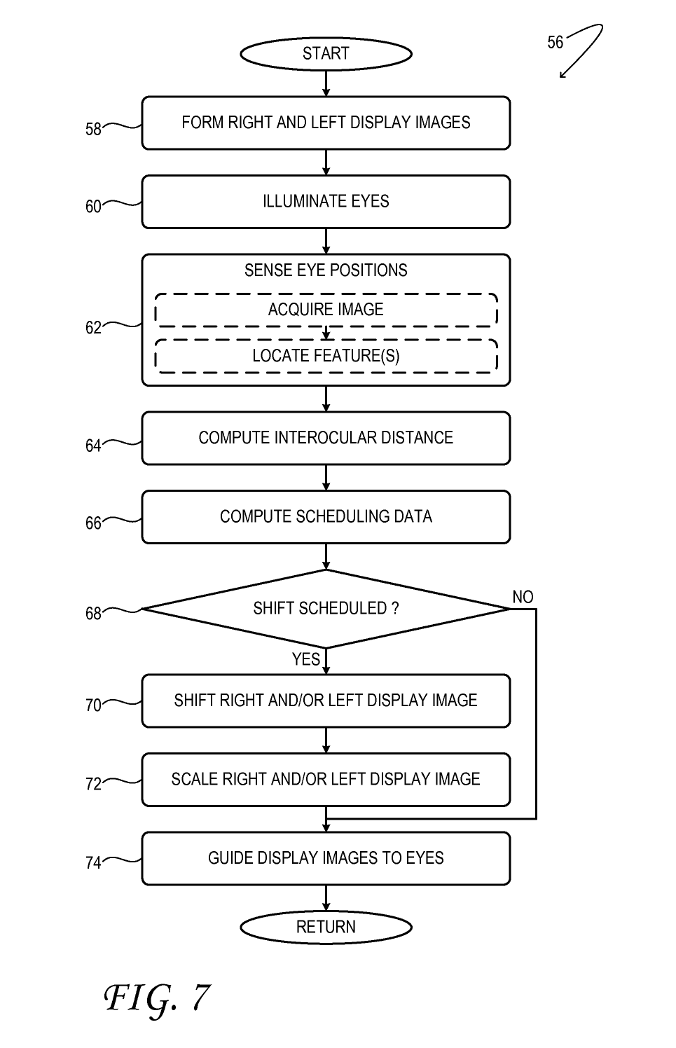

FIG. 7 illustrates an example method 56 to display a virtual object at a specified distance in front of an observer. In this method, right and left display images of the virtual object are shifted so that the positional disparity between the right and left display images is parallel to an interocular axis of the observer, in an amount to place the virtual object at the specified distance. This method may be enacted in a wearable, stereoscopic display system, such as display system 10 described hereinabove.

At 58 of method 56, right and left display images corresponding to the virtual object to be displayed are formed in logic of the computer system and/or display system. This action may include accumulating the right and left display images in frame buffers of one or more GPUs of the computer system. In some embodiments, this action may also include transmitting the frame-buffer data to right and left display image-forming arrays of the display system.

At 60 each of the observer's eyes is illuminated to enable eye tracking. As described hereinabove, the illumination may include narrow-angle illumination to create one or more corneal glints to be imaged or otherwise detected. At 62, the positions of the right and left eyes of the observer are sensed by eye-tracking componentry of the display system. Such componentry may sense the positions of any feature of the eye. In some embodiments, the various feature positions may be determined relative to a frame of reference fixed to the display system. In other embodiments, a feature position of the right eye may be determined relative to a feature position of the left eye, or vice versa.

In one embodiment, the eye positions sensed at 62 may include the instantaneous pupil positions of the right and left eyes. The term ‘instantaneous,’ as used herein, means that measurements are conducted or averaged over a time interval which is short compared to the timescale of motion of the eye. In another embodiment, the eye positions sensed at 62 may include a position of a center of rotation of each pupil about the respective eye. Here, the sensing action may include making repeated measurements of instantaneous pupil position of each eye, and combining such measurements to yield the position of the center of rotation of each eye.

Any suitable tactic may be used to sense the positions of the eyes or any feature thereof, including non-imaging sensory methods. In other embodiments, however, the eye positions are sensed by acquiring one or more high-contrast images of each eye—e.g., an image of the right eye and a separate image of the left eye—and analyzing the high-contrast images to locate one or more ocular features. Such features may include, for example, a center position of a pupil of the eye, an outline of the pupil of the eye, and a glint reflected from a cornea of the eye.

At 64 the sensed eye positions are combined to define an interocular axis of the observer in the frame of reference of the display system and to compute a corresponding interocular distance. The nature of the interocular axis and interocular distance may differ in the different embodiments of this disclosure. In the embodiments in which the instantaneous pupil position is sensed and used to shift the right and left display images, the interocular axis of 64 may be the observer's interpupilary axis, and the interocular distance may be the instantaneous distance between pupil centers. On the other hand, in embodiments in which the center of rotation of the pupil is sensed and used to shift the right and left display images, the interocular axis may be the axis passing through the centers of rotation of each pupil.

At 66 is computed scheduling data that defines one or more intervals over which a shift in the right or left display image of the virtual object is to be made. The scheduling data may be such that the shifting of the right or left display image is least apparent or least distracting to the observer. For example, the scheduling data may provide that the one or more intervals includes an interval during which the observer is looking away from the virtual object being displayed. In other examples, the one or more intervals may be distributed over time so that the shifting of the right or left display image is unnoticeable to the observer. In other examples, the one or more intervals may follow motion of the display system relative to one or both of the observer's eyes, or may follow an abrupt change in a head or eye position of the observer, as revealed by an accelerometer of the display system.

At 68, accordingly, it is determined whether a shift in the right or left display image is scheduled in the current interval. If a shift is scheduled, then the method advances to 70, where the right or left display image is shifted based on the positions of the right and left eyes. In general, the right and/or left display images may be shifted relative to a frame of reference fixed to the display system. Further, the shift in the right or left display image may include, at a minimum, a shift in the ‘vertical’ direction—i.e., a direction perpendicular to the interocular axis and perpendicular to a direction the observer is facing. In one embodiment, only the right or the left display image is shifted to effect the disparity correction, while in other embodiments, both the right and left display images are shifted appropriately.

In one embodiment, the shift may be enacted by translating each pixel of the right display image by a computed amount within the right image frame. In another embodiment, each pixel of the left display image may be translated by a computed amount within the left image frame, and in other embodiments, the left and right display images may be translated by different amounts within their respective image frames. In still other embodiments, the right and/or left display images may be shifted by sending appropriate analog signals to tunable optics in the display system, shifting, in effect, the image frames in which the right and left display images are displayed.

In each of these embodiments, the magnitude and direction of the shift may be based computationally on the positions of the observer's eyes as determined at 62—e.g., on a location of an ocular feature of the right eye in a high-contrast image of the right eye, relative to the location of an ocular feature of the left eye in a high-contrast image of the left eye. In particular, the magnitude and direction of the shift may be such as to confine the positional disparity between the right and left display images to a direction parallel to the interocular axis of the observer, in an amount to place the virtual object at the specified distance. In this manner, the positional disparity between the right and left display images is limited to ‘horizontal’ disparity, which will not induce unnatural accommodation attempts by the observer. Further, the amount of horizontal disparity may be related to the specified depth of each pixel of the virtual object Z relative to the depth of the focal plane Z₀ and the on the interocular distance computed at 64.

As noted above, the particular interocular axis used in method 56 may differ from one embodiment to the next. In some embodiments, an instantaneous interpupilary axis (derived from instantaneous pupil positions) may be used. In other embodiments, it may be preferable to draw the interocular axis through the centers of rotation of each pupil and to confine the positional disparity between the right and left display images to that axis.

In the embodiment of FIG. 7, the shifting of the right and/or left display image is accompanied, at 72, by appropriate scaling of the right and/or left display image so that the virtual image appears at the specified distance from the observer. In one embodiment, the right or left display image may be scaled by a geometric factor based on the interocular distance computed at 64 of method 56.

Finally, at 74 the right display image is guided through optical componentry of the display system to the right eye of the observer, and the left display image is guided to the left eye of the observer.

As evident from the foregoing description, the methods and processes described herein may be tied to a computing system of one or more computing machines. Such methods and processes may be implemented as a computer-application program or service, an application-programming interface (API), a library, and/or other computer-program product.

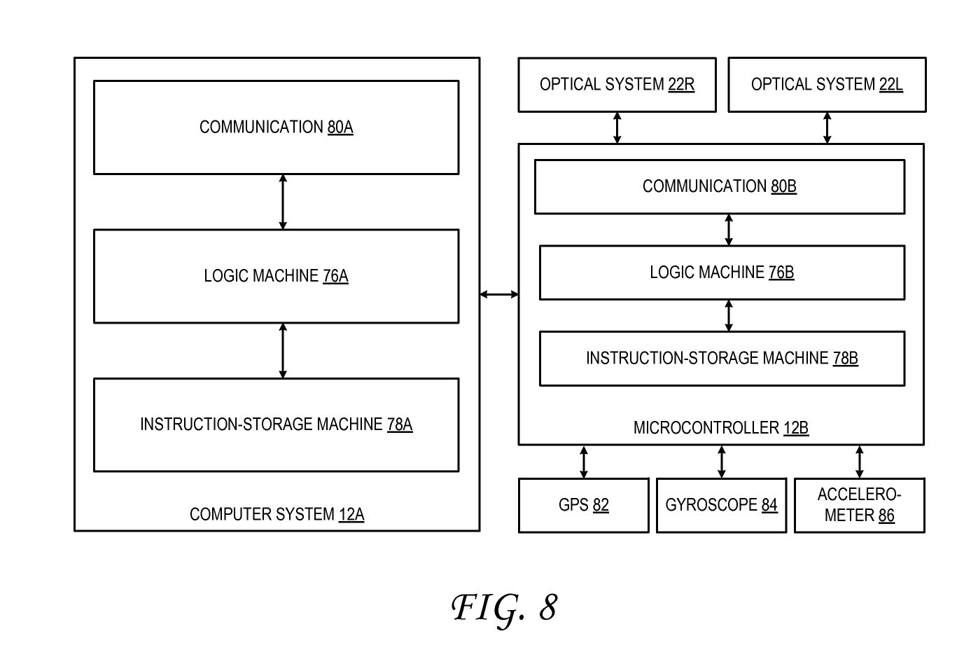

Shown in FIG. 8 in simplified form is a non-limiting example of a computing system used to support the methods and processes described herein. Each computing machine 12 in the computing system includes a logic machine 76 and an instruction-storage machine 78. The computing system also includes a display in the form of optical systems 22R and 22L, communication systems 80A and 80B, GPS 82, gyroscope 84, accelerometer 86, and various components not shown in FIG. 8.

Each logic machine 76 includes one or more physical devices configured to execute instructions. For example, a logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Each logic machine 76 may include one or more processors configured to execute software instructions. Additionally or alternatively, a logic machine may include one or more hardware or firmware logic machines configured to execute hardware or firmware instructions. Processors of a logic machine may be single-core or multi-core, and the instructions executed thereon may be configured for sequential, parallel, and/or distributed processing. Individual components of a logic machine optionally may be distributed among two or more separate devices, which may be remotely located and/or configured for coordinated processing. Aspects of a logic machine may be virtualized and executed by remotely accessible, networked computing devices configured in a cloud-computing configuration.

Each instruction-storage machine 78 includes one or more physical devices configured to hold instructions executable by an associated logic machine 76 to implement the methods and processes described herein. When such methods and processes are implemented, the state of the instruction-storage machine may be transformed—e.g., to hold different data. An instruction-storage machine may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. An instruction-storage machine may include volatile, nonvolatile, dynamic, static, read/write, read-only, random-access, sequential-access, location-addressable, file-addressable, and/or content-addressable devices.

It will be appreciated that each instruction-storage machine 78 includes one or more physical devices. However, aspects of the instructions described herein alternatively may be propagated by a communication medium (e.g., an electromagnetic signal, an optical signal, etc.) that is not held by a physical device for a finite duration.

Aspects of the logic machine(s) and instruction-storage machine(s) may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms ‘module,’ ‘program,’ and ‘engine’ may be used to describe an aspect of a computing system implemented to perform a particular function. In some cases, a module, program, or engine may be instantiated via a logic machine executing instructions held by an instruction-storage machine. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ ‘program,’ and ‘engine’ may encompass individual or groups of executable files, data files, libraries, drivers, scripts, database records, etc.

It will be appreciated that a ‘service’, as used herein, is an application program executable across multiple user sessions. A service may be available to one or more system components, programs, and/or other services. In some implementations, a service may run on one or more server-computing devices.

Communication system 80 may be configured to communicatively couple a computing machine with one or more other machines. The communication system may include wired and/or wireless communication devices compatible with one or more different communication protocols. As non-limiting examples, a communication system may be configured for communication via a wireless telephone network, or a wired or wireless local- or wide-area network. In some embodiments, a communication system may allow a computing machine to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. Enacted in a stereoscopic display system, a method to display a virtual object at a specified distance in front of an observer, the method comprising:
sensing a position of a right eye of the observer;
sensing a position of a left eye of the observer;
based on the positions of the right and left eyes, shifting a right or left display image of the virtual object so that positional disparity between the right and left display images is parallel to an interocular axis of the observer, in an amount to place the virtual object at the specified distance; and
guiding the right display image to the right eye and the left display image to the left eye.

2. The method of claim 1, wherein shifting the right or left display image includes shifting in a vertical direction, perpendicular to the interocular axis and perpendicular to a direction the observer is facing.

3. The method of claim 1, further comprising shifting both the right and left display images so that the positional disparity between the right and left display images is parallel to the interocular axis, in an amount to place the virtual object at the specified distance.

4. The method of claim 1, further comprising scaling the right or left display image.

5. The method of claim 1, wherein the positions of the right and left eyes include instantaneous pupil positions of the right and left eyes, and wherein the interocular axis is an interpupilary axis.

6. The method of claim 1, wherein the positions of the right and left eyes include a position of a center of rotation of each pupil about the respective eye, and wherein the interocular axis is an axis passing through the centers of rotation of each pupil, the method further comprising:
making repeated measurements of an instantaneous pupil position of each eye and combining such measurements to yield the position of the center of rotation of each pupil.

7. The method of claim 1, further comprising computing an interocular distance between the right and left eyes based on the positions of the right and left eyes.

8. The method of claim 1, further comprising forming the right and left display images, wherein the right display image is formed on a display screen using light of one polarization state, and the left display image is formed on the same display screen using light of different polarization state.

9. The method of claim 1, further comprising forming the right and left display images, wherein the display system is a near-eye display system in which the right display image appears behind a right display window, and the left display image appears behind a left display window.

10. The method of claim 1, further comprising:
forming the right and left display images alternately, where guiding the right and left display images includes guiding to each of a right display window and a left display window; and
alternately opening an electro-optical shutter of the right display window and an electro-optical shutter of the left display window so that the right display image is presented only to the right eye, and the left display image is presented only to the left eye.

11. The method of claim 1, wherein sensing the positions of the right and left eyes includes, for each eye:
acquiring a high-contrast image of the eye; and
locating a feature of the eye in high-contrast image, wherein the shift is based on a location of the feature in the high-contrast image.

12. The method of claim 11, wherein the feature includes one or more of a center position of a pupil of the eye, an outline of the pupil of the eye, and a glint reflected from a cornea of the eye.

13. A wearable, stereoscopic display system for displaying a virtual object at a specified distance in front of a wearer of the display system, the display system comprising:
one or more sensors configured to sense a position of a right eye of the wearer and a position of a left eye of the wearer;
logic configured to form right and left display images of the virtual object and to shift the right or left display image based on the positions of the right and left eyes, the shift being of such magnitude and direction as to confine positional disparity between the right and left display images to a direction parallel to an interocular axis of the wearer, in an amount to place the virtual object at the specified distance; and
an optical system configured to guide the right and left display images to the right and left eyes of the wearer.

14. The display system of claim 13, wherein the optical system includes at least one see-thru pupil expander arranged forward of the right and left eyes of the wearer when the display system is worn by the wearer.

15. The display system of claim 13, wherein the one or more sensors includes a camera.

16. Enacted in a stereoscopic display system, a method to display a virtual object at a specified distance in front of an observer, the method comprising:
sensing positions of right and left eyes of the observer;
computing scheduling data defining one or more intervals over which a shift in a right or left display image of the virtual object is to be made;
in the one or more intervals defined in the scheduling data, shifting the right or left display image based on the positions of the right and left eyes so that positional disparity between the right and left display image is parallel to an interocular axis of the observer, in an amount to place the virtual object at the specified distance; and
guiding the right display image to the right eye and the left display image to the left eye.

17. The method of claim 16, wherein the one or more intervals includes an interval during which the observer looks away from the virtual object.

18. The method of claim 16, wherein the one or more intervals includes intervals distributed over time so that the shifting of the right or left display image is unnoticeable to the observer.

19. The method of claim 16, wherein the one or more intervals are scheduled to follow motion of the display system relative to the right or left eye of the observer.

20. The method of claim 16, wherein the one or more intervals are scheduled to follow an abrupt change in a head or eye position of the observer.
